(19) United States
(12) Patent Application Publication
(10) Pub. No.: US 2020/0342310 A1
(43) Pub. Date: Oct. 29, 2020

(54) IDENTIFYING DATA DRIFTS

(71) Applicant: International Business Machines Corporation, Armonk, NY (US)

(72) Inventors: Eitan Farchi, Pardes Hanna (IL); Orna Raz, Haifa (IL); Marcel Zalmanovici, Kiriat Motzkin (IL); Aviad Zlotnick, Mitzpeh Netopfah (IL)

(21) Appl. No.: 16/396,717

(22) Filed: Apr. 28, 2019

(51) Int. Cl. G06N 3/08; G06N 5/02

(52) U.S. Cl. CPC G06N 3/08; G06N 5/02

(57) ABSTRACT

A method, apparatus and product for identifying data drifts. The method comprising: obtaining a seen dataset, wherein the seen dataset comprises seen instances, each of which comprising feature values in a feature space; determining a first measurement of a statistical metric of the seen dataset; obtaining an unseen dataset, wherein the unseen dataset comprises unseen instances, each of which comprising features values in the feature space; determining a second measurement of the statistical metric of the unseen dataset; identifying a data drift in the unseen dataset with respect to the seen dataset based on the first and second measurements of the statistical metric; and performing a responsive action based on the identification of the data drift.

### TECHNICAL FIELD

The present disclosure relates to predictive models in general, and to identifying data drifts that potentially reduce the quality of predictions by the predictive models, in particular.

### BACKGROUND

Machine learning algorithms are at the front of academic research as well as commercialized services and products. As the problem of finding a predictive model is almost solved, new problems arising. One problem is the robustness of predictive models outside the lab.

Predictive models, such as implementing Machine Learning techniques, depend on data. The predictive model may be as good as the data that was used in order to train it. If the training data provides an adequate representation of the real world data, the predictive model is likely to provide relative good predictions when used in production. Once the model is trained and is being used in order to make real predications in real life scenarios, it may encounter data that is substantially different than the data that was used in order to train the model, and as a result, it may provide unreliable predictions and generally perform below par.

### BRIEF SUMMARY

One exemplary embodiment of the disclosed subject matter is a method comprising: obtaining a seen dataset, wherein the seen dataset comprises seen instances, each of which comprising feature values in a feature space; determining a first measurement of a statistical metric of the seen dataset; obtaining an unseen dataset, wherein the unseen dataset comprises unseen instances, each of which comprising features values in the feature space; determining a second measurement of the statistical metric of the unseen dataset; identifying a data drift in the unseen dataset with respect to the seen dataset based on the first and second measurements of the statistical metric; and performing a responsive action based on the identification of the data drift.

Another exemplary embodiment of the disclosed subject matter is a computerized apparatus having a processor and coupled memory, the processor being adapted to perform the steps of: obtaining a seen dataset, wherein the seen dataset comprises seen instances, each of which comprising feature values in a feature space; determining a first measurement of a statistical metric of the seen dataset; obtaining an unseen dataset, wherein the unseen dataset comprises unseen instances, each of which comprising features values in the feature space; determining a second measurement of the statistical metric of the unseen dataset; identifying a data drift in the unseen dataset with respect to the seen dataset based on the first and second measurements of the statistical metric; and performing a responsive action based on the identification of the data drift.

Yet another exemplary embodiment of the disclosed subject matter is a non-transitory computer readable medium retaining program instructions, which program instructions when read by a processor, cause the processor to perform: obtaining a seen dataset, wherein the seen dataset comprises seen instances, each of which comprising feature values in a feature space; determining a first measurement of a statistical metric of the seen dataset; obtaining an unseen dataset, wherein the unseen dataset comprises unseen instances, each of which comprising features values in the feature space; determining a second measurement of the statistical metric of the unseen dataset; identifying a data drift in the unseen dataset with respect to the seen dataset based on the first and second measurements of the statistical metric; and performing a responsive action based on the identification of the data drift.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows an illustration of data projection, in accordance with some exemplary embodiments of the disclosed subject matter;

FIG. 3 shows a flowchart diagram of a method, in accordance with some exemplary embodiments of the disclosed subject matter;

FIG. 4 shows an illustration of an autoencoder, in accordance with some exemplary embodiments of the disclosed subject matter; and

FIG. 5 shows a block diagram of an apparatus, in accordance with some exemplary embodiments of the disclosed subject matter.

### DETAILED DESCRIPTION

One technical problem dealt with by the disclosed subject matter is to determine whether an unseen dataset is statistically different than a seen dataset. In some exemplary embodiments, the seen dataset may comprise a training dataset, a testing dataset, or the like. Additionally or alternatively, an unseen dataset may correspond to a production dataset. A predictive model may have been trained using a seen dataset and may have been tested and validated using another seen dataset. In some exemplary embodiments, a seen dataset, whether labeled or not, may be divided into subsets, based on a desired proportion (e.g., 66:34; 80:20; 50:50, or the like), so as to create a training dataset and a testing dataset.

In some exemplary embodiments, once the model is in use, an unseen dataset may be statistically different compared to the seen dataset(s). In some exemplary embodiments, the hardware that is being used for obtaining the unseen dataset may be different than the hardware that was used for obtaining the seen dataset, the data sources may have changed, or the like. As an example, a predictive model may be used in order to decide, based on mammographic images, whether people have a cancer or not. During the lifetime of an X-Ray scanner, the filament may burn out, the tube may start to leak, or the like. As a result, during the lifetime of an X-Ray scanner, images taken by the X-Ray scanner may be of different quality. Additionally or alternatively, during the lifetime of an X-Ray scanner, there may be a degradation in the quality of the scans. The different quality may cause a predictor to provide erroneous results, as it was trained using a statistically different dataset. As another example, a predictive model may be trained in order to read road signs. The model may be in use in an area in which the road signs have faded. In case that the model was not trained using faded road signs, it may fail reading faded road signs.

Another technical problem dealt with by the disclosed subject matter is to identify a data drift based on a failed correlation between a seen dataset and an unseen dataset. In some exemplary embodiments, a predictive model may have been trained and/or tested using the seen dataset. The predictive model may be applied on instances comprising the unseen dataset. It may be desired that both the seen dataset and the unseen dataset shall have (substantially) the same distribution.

One technical solution is to compare a statistical metric of the seen dataset with the statistical metric in the unseen dataset. In some exemplary embodiments, a seen dataset may be obtained. In some exemplary embodiments, the seen dataset may comprise seen instances. Each seen instance may comprise feature values in a feature space. In some exemplary embodiments, the feature space may be an N dimensional space, where N is the number of features used to represent the instance. It is noted that some features may be obtained directly from the raw data, some features may be engineered features that are computed based on the raw data, or the like. In some exemplary embodiments, a first measurement of a statistical metric of the seen dataset may be determined.

In some exemplary embodiments, an unseen dataset, comprising unseen instances may be obtained. Based on the statistical metric, a second measurement may be determined. The second measurement may be a statistical measurement of the unseen dataset.

In some exemplary embodiments, the first and second statistical measurements may be indicative of the distributions of instances or portions thereof in the seen dataset and in the unseen dataset. In case that the distributions are different, a data drift may be identified. The data drift may be a data drift in the unseen dataset with respect to the seen dataset. In some exemplary embodiments, a data drift may be identified based on a difference in the measurements that is above a predetermined threshold, such as an absolute threshold, a relative threshold, or the like.

In some exemplary embodiments, in response to identifying a data drift, a responsive action may be taken. The responsive action may comprise a hardware replacement, sending a notification to a user, such as by email or by a push notification, or the like. As an example, the user may be responsible to the above mentioned X-Ray scanner. In response to identifying a data drift, an email may be sent to the user, warning him regarding a potential flaw in the X-Ray scanner. Additionally or alternatively, an automated process for replacing an X-Ray tube may be initiated.

In some exemplary embodiments, the responsive action may comprise obtaining a new seen dataset. Referring again to the above mentioned signs example, in case that new signs were introduced, it may be desired to retrain the predictive model with the new signs as the seen data. The new seen dataset may comprise a portion of the seen dataset, a portion of the unseen data set, a combination thereof, or the like.

Another technical solution may comprise projecting the instances to a sub-space in order to determine the first measurement and the second measurement. The projection may be from the N-dimension feature space to a smaller feature space. In some exemplary embodiments, features retained in the smaller feature space may be indicative of important qualities of the seen dataset and the unseen dataset, in general or with respect to the goals of the predictive model. Additionally or alternatively, finding statistical relations between the seen dataset and the unseen dataset may be more efficient when applied on a smaller space with respect to the number of dimensions.

In some exemplary embodiments, determining the first measurement of the statistical metric may comprise projecting the instances of the seen dataset to a sub-space in order to reduce the number of dimensions on which the first statistical measurement is applied. In some exemplary embodiments, determining the second measurements of the statistical metric may comprise projecting the instances to the feature sub-space. In some exemplary embodiments, projecting to a smaller sub-space may be performed by applying a trained Artificial Neural Network (ANN) on the instances of the seen dataset and on instances of the unseen dataset. Additionally or alternatively, projecting to a smaller sub-space may be performed by applying a method such as Principal Component Analysis (PCA) on the seen dataset and on the unseen dataset. The statistical measurement may be the resulting variance of the PCA. A variance that is above a predetermined threshold may be indicative of a data drift. For example, a variance that is above 0.5 points, may be indicative of a data drift. In case that a data drift was identified, the responsive action may comprise re-training the predictive model. In some cases, the predictive model may be re-trained using at least a portion of the unseen data.

It is noted that the predictive model may implement any predictive technique, including machine learning techniques. The disclosed subject matter may utilize a model that is separate and independent of the predictive model. For example, the predictive model may be implemented using ANN, Support-Vector Machine (SVM), k-means clustering, or the like. The data drift may be determined based on a different model, even if such model may implement the same technique, such as ANN.

Another technical solution is to utilize an encoding-decoding function to determine the measurements of the statistical metric. The encoding-decoding function may be configured to transform an instance in the feature space to a decoded instance in the feature space. The instance in the feature space may be a seen instance, an unseen instance, or the like. The operation of the encoding-decoding function may comprise transforming an instance given in the feature space to an encoded instance in an encoded sub-space. The operation may further comprise transforming the encoded function to a decoded instance in the feature space.

In some exemplary embodiments, the encoding-decoding may be applied on instances comprising the seen dataset. For each pair of seen instance and a decoded-seen instance a difference therebetween may be computed. The first measurement may be computed based on a statistical metric of the above differences. Additionally or alternatively, the encoding-decoding function may be applied on instances comprising the unseen dataset. For each pair of unseen instance and a decoded unseen distance a difference therebetween may be computed. The second measurement may be computed based on the statistical metric of the above differences.

As an example, the encoding decoding function may be determined using an autoencoder. The autoencoder may be an artificial neural network used to learn efficient data codings in an unsupervised manner. In some exemplary embodiments, the aim of an autoencoder may be to learn a representation (encoding) for a dataset, for dimensionality reduction, by training the network to ignore “noisy” signals. In some exemplary embodiments, along with the reduction side, a reconstructing side is learnt, where the autoencoder tries to generate from the reduced encoding a representation as close as possible to its original input, hence its name. In some exemplary embodiments, for each or some of the seen instances, s[i], a decode-seen instance ds[i] may be computed. In some exemplary embodiments, ds[i] may be computed as follows: ds[i]=dec(enc(s[i])). In some exemplary embodiments, for each instance in the seen dataset, a value of a delta function (Δ) may be computed. The delta function may be defined as follows: Δ(i)=i−dec(enc(i)), wherein i is the each instance, wherein enc(i) is an encoding function from the feature space to the encoded feature space, wherein dec(x) is a decoding function from the encoded feature space to the feature space, wherein dec(enc(i)) is the encoding-decoding function. In some exemplary embodiments, the values of the delta function in the seen dataset may be viewed as a random variable. Statistical metric of the random variable, such as average value, variance, or the like, may be computed with respect to the seen dataset. Similarly, the same statistical metric may be computed with respect to the unseen dataset, based on the values of the delta function in the unseen dataset. In some exemplary embodiments, the data drift may be identified based on a difference between the different measurements of the statistical metric being above a predetermined threshold.

Another technical solution is to find significant qualities of the seen dataset and of the unseen dataset. As an example, the significant qualities may be the features that affect the data most. For example, in case of prediction of a salary of a person, the eye color and hair color features may have little significance in predicting the person's wage. The features of gender, education level and age, on the other hand, may, alone, provide a good prediction. It may be said that these features represent the significant qualities of s the data with respect to the salary prediction task. Additionally or alternatively, the significant qualities may be represented by a combination of features. For example, in a dataset where a gender is not provided, height and weight features may be combined to provide a gender prediction, which in turn may provide important information for the wage prediction. In some exemplary embodiments, the significant qualities may be determined automatically using an autoencoder. Additionally or alternatively, the significant qualities may be extracted from a predictive model, such as by examining weights associated, by the predictive model, with each feature, and selecting the top-weighted features. In some exemplary embodiments, the significant qualities may be determined based on the predictive model, and may be analyzed for data drift identification using another model. In some exemplary embodiments, data drift may be identified based on a difference in a correlation between the significant qualities, as embodied in the seen dataset and in the unseen dataset.

One technical effect of utilizing the disclosed subject matter is to provide an automated manner indicative of a hardware malfunction that adversely affects capturing of production dataset. As an example, in case that the unseen dataset is a mammographic image and in case that a data drift was identified, it may be indicative that the tube may need a replacement.

Another technical effect of utilizing the disclosed subject matter is to provide an indication to the quality of the model when unseen dataset is in use. In some exemplary embodiments, a predictive model may be valid with respect to the seen dataset and with respect to a portion of the unseen dataset. However, some variation of the unseen dataset may not have been represented in the seen dataset. Referring again to the above road signs example, identifying a data drift may indicate that the signs that caused the adverse data drift may not have been adequately represented by the seen dataset. A remedy may be accomplished by adding data from the unseen dataset to the seen dataset and retraining the predictive model based thereon.

Another technical effect may be to provide an efficient method for data drift identification that is independent of the predictive model. The disclosed subject matter may be utilized in any stage of the life cycle of the usage of the predictive model, such as before the predictive model is trained, during the training thereof, during validation thereof, during usage of the predictive model in real-life scenarios, or the like.

Another technical effect may be to provide an efficient method for data drift identification. In some exemplary embodiments, instead of tracking each and every possible statistical metric representing the seen dataset in its original feature space, a smaller feature space may be utilized, with potentially minimal loss of important information and potentially maximal loss of non-important information. The smaller feature space may be represented by a reduced number of statistical metrics to be utilized for data drift identification.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

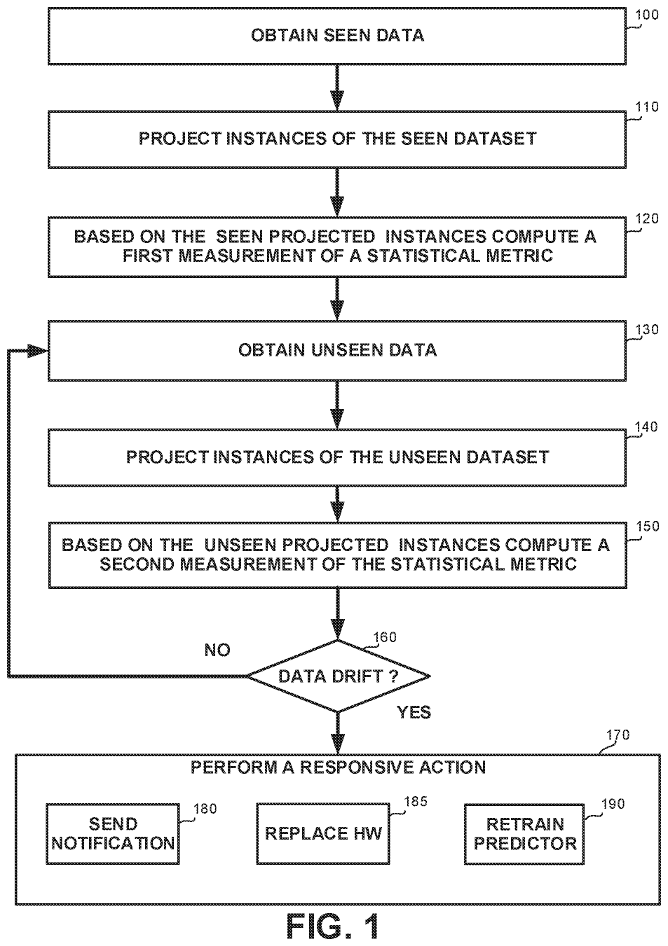

Referring now to FIG. 1 showing a flowchart diagram of a method, in accordance with some exemplary embodiments of the disclosed subject matter.

On Step 100, a seen dataset is obtained. The seen dataset may comprise instances. Each instance may comprise features values. The feature values may be comprised in a feature space. In some exemplary embodiments, the feature space may be an N dimensional space, where N may be the number of features. In some exemplary embodiments, some or all of the features may represent raw data, may be engineered features, or the like.

On Step 110, seen instances may be projected to a second feature space. The second feature space may be smaller than the feature space, may have fewer dimensions, or the like. In some exemplary embodiments, instead of having N features, the second feature space may have M features, where M<N. In some exemplary embodiments, projecting the seen instances may be performed using a trained Artificial Neural Network (ANN), Principal Component Analysis (PCA), or the like. In some exemplary embodiments, the smaller feature space may be defined by features that are a subset of the features defining the feature space. The features that are defining the smaller feature space may be the important features, the most significant features, features embodying the important qualities with respect to a predictive task, or the like.

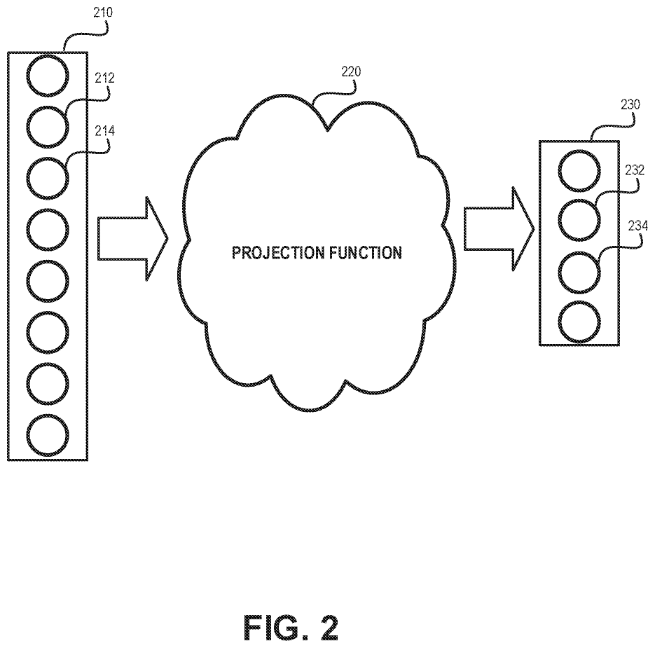

FIG. 2 exemplifies a projection of an instance given in the feature space, Input Vector 210, using a Projection Function 220, in order to obtain a projection in a feature space having a reduced dimensionality, Output Vector 230. As is schematically illustrated in FIG. 2, instead of an 8-dimension space, the instances are projected to a feature space having 4 dimensions.

On Step 120, a first measurement may be computed. The first measurement may be a measurement of a statistical metric of the seen dataset. The statistical metric may be based on the correlation between at least two features in the smaller space. For example, referring to FIG. 2, the statistical metric may be a correlation between Features 232 and 234. Additionally or alternatively, the statistical metric may be a fitness measurement of a regression using each feature of Output Vector 230 except for Feature 232, with the value of Feature 232. In some exemplary embodiments, for each pair of features in the second feature space, a relation-based metric, such as correlation, co-variance, or the like, may be computed. Additionally or alternatively, each subset of M−1 features in the second feature space and its relation with the remaining M^{th} feature may be computed. Additionally or alternatively, the statistical metric may be any statistical manner of representing a distribution of data, such as random variables of metric associated therewith, mean value of a feature, a variance of values of a feature, standard deviation in values of a feature, or the like.

On Step 130, an unseen dataset is obtained. The unseen dataset may comprise unseen instances, each of which may comprise feature values in the feature space. The unseen dataset may comprise instances for which a predictor may be utilized to predict a label. Additionally or alternatively, the predictor may be configured to predict a next unseen instances based on one or more unseen instances. In some exemplary embodiments, the predictor may utilize a predictive model, which may be independent and separate from any model utilized by the disclosed subject matter, including any model utilized to determine the measurements of the statistical metric.

On Step 140, unseen instances comprising the unseen dataset may be projected to the second feature space. It is noted that projecting unseen instances may be performed s using the same projecting function of Step 110.

On Step 150, based on the projected unseen instances, a second measurement may be computed. The second measurement may be a measurement of the same statistical metric of Step 120.

On Step 160, it may be determined whether a data drift occurred. In some exemplary embodiments, a data drift may be identified based on a substantial change in the second measurement (of Step 150) from the first measurement (of Step 120). In some exemplary embodiments, a data drift may be identified based on a difference between the first measurement and the second measurement that is above a predetermined threshold, such as an absolute threshold, a relative threshold, or the like.

In some exemplary embodiments, a data drift may reduce the likelihood that a predictor would provide a correct prediction. Additionally or alternatively, a data drift may result in a predictive model being over-fitted, or the like.

In some exemplary embodiments, if a data drift is identified, Step 170 may be performed. Otherwise, if no data drift was identified, Steps 130-160 may be performed again, and additional unseen instances may be obtained and used for analysis.

On Step 170, a responsive action may be performed. The responsive action may be an action that is aimed to notify a responsible entity regarding the data drift. In some cases, the unseen dataset may comprise instances of low quality, the responsive action may comprise a mitigating action aimed at improving the quality of the instances that are obtained.

On Step 180, a notification, such as a push notification, an email, or the like, may be sent. in some exemplary embodiments, the notification may be provided in order to make users aware to the data drift. As an example, referring again to the road signs example, in case that a data drift was identified, a notification may be sent to people using a navigation software utilizing the predictor. The notification may warn drivers regarding potential problems. Additionally or alternatively, referring again to the X-Ray example, an email may be sent to a doctor, warning her regarding potential poor quality of X-Ray scans. Additionally or alternatively, the notification may be provided to users who can correct potential issues, such as administrators, quality assurance personnel, or the like.

On Step 185, the hardware that was used in order to obtain the unseen data may be replaced. For example, the hardware used to obtain the instances may be malfunctioning, degraded, worn out, or the like. In such a case, the hardware may be replaced, manually or automatically. In some exemplary embodiments, a data drift may be indicative of an unseen data of low quality. As an example, a predictive model may be used in order to decide if a handwritten manuscript was written by Aristotle or by Plato. A data drift may be indicative of a malfunctioning scanner, providing problematic images, such as too bright, too dark, or the like. As another example, a predictor may have been trained in order to diagnose cancer in X-Ray images. A data drift may be indicative of a hardware malfunction that causes a disruption in the produced X-Ray images, such as, for example a leaking tube in the X-Ray scanner, a burned out filament, or the like.

On Step 190, the predictor may be retrained. In some exemplary embodiment, a data drift may occur despite a non-malfunction hardware. The unseen data that caused the data drift may be proper data. However, a portion of the unseen data may not have been adequately represented in the seen data. Additionally or alternatively, the unseen data may be different than the seen data due to other reasons, such as a change occurring in the real-world. For example, traffic sign analysis may be trained using images of new signs. If in the real world, existing signs fade, the unseen dataset may differ and the predictor may perform relatively poorly. As yet another example, a law change may cause a new sign to appear. Such a sign may not have been represented in the seen data as it did not exist at that time.

In some exemplary embodiments, the predictor may be trained using a new training data. The new training data may comprise the unseen data or portion thereof. It is noted that if the predictor utilizes an unsupervised learning technique, such as ANN, clustering, or the like, the unseen instances may be used without obtaining a correct label thereof. In some exemplary embodiments, the new training data may comprise the (old) seen data, or portion thereof. In some exemplary embodiments, new training data may be obtained from other sources, irrespective of production data. In some exemplary embodiments, the new training data may be used in order to retrain the predictor. In some exemplary embodiments, during training, it may be verified that the new training data does not exhibit a data drift with respect to the unseen dataset of Step 130, in which a data drift from the seen dataset of Step 100 was identified.

Referring now to FIG. 2 showing an illustration of data projection, in accordance with some exemplary embodiments of the disclosed subject matter.

In some exemplary embodiments, a data instance, represented by Input Vector 210, may be projected using Projection Function 220, to obtain Output Vector 230.

Input Vector 210 may be a vector of features representing an instance. Input Vector 210 may comprise valuations of each feature, as defined by the instance, such as for example, a raw value, a calculated value based on normalization, a calculated value based on a plurality of raw values, or the like.

In some exemplary embodiments, Projection Function 220 may be configured to copy a value of a feature from Input Vector 210 to Output Vector 230. For example, Feature 232 may be retain the value of Feature 212. Additionally or alternatively, Projection Function 220 may be configured to compute values for Output Vector 230 based on a plurality of features of Input Vector 210. For example, Feature 234 may be computed based on the values of Features 212 and 214.

In some exemplary embodiments, Projection Function 220 may be a trained ANN. The ANN may be trained using Convolutional Neural Network (CNN), Recurrent Neural Network (RNN), or the like. Projection Function 220 may be used in order to project Input Vector 210 from an N dimension space to a space having a reduced dimensionality, M.

Additionally or alternatively, Projection Function 220 may utilize a PCA. Using PCA, a set of principal components may be determined and utilized to represent Input Vector 210. As a result, instances may be projected to a second feature space, comprising features that correspond a weight given to each principal component to represent the instance. For example Feature 232 may be a weight given to the second principal component in the set. In some exemplary embodiments, the set of principal components may be a partial set of principal components, such as the top M principal components.

Output Vector 230 may be the result of applying Projection Function 220 on Input Vector 210. In the illustrated example, Output Vector 230 may represent an instance s in a 4-dimensional feature space, while Input Vector 210 is given in an 8-dimensional feature space. In some exemplary embodiments, reducing the number features may yield the features embodying important qualities of Input Vector 210 with respect to the prediction task. In some exemplary embodiments, reduced dimensionality may reduce a number of statistical measurements being computed to identify data drifts.

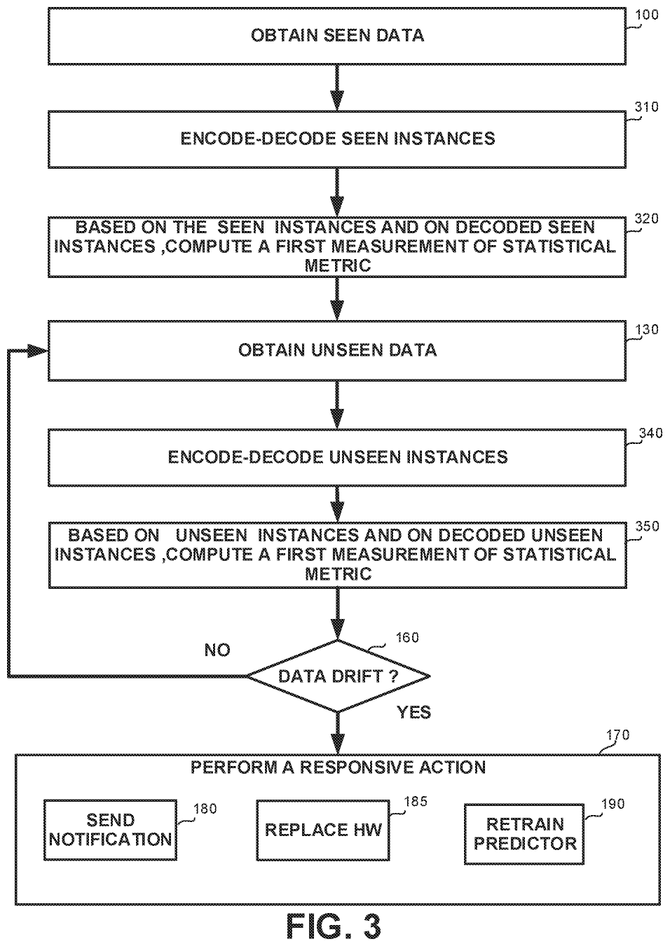

Referring now to FIG. 3 showing a flowchart diagram of a method, in accordance with some exemplary embodiments of the disclosed subject matter.

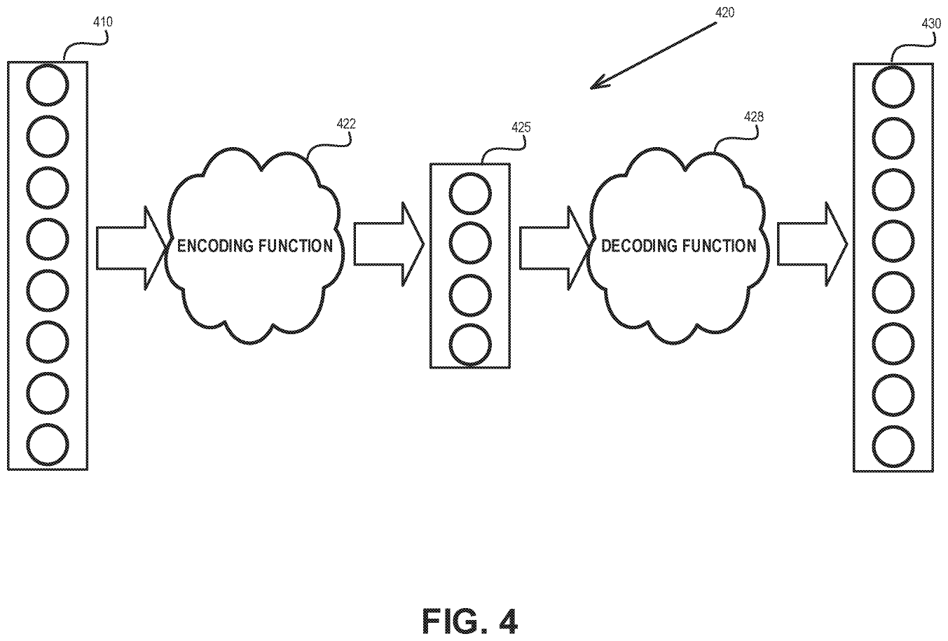

On Step 310, seen instances may be encoded and decoded to obtain decoded seen instances. The encoding and decoding may be performed using an encoding function encoding the instance from a feature space to an encoded feature space, such as a feature space having a reduced number of dimensions. The encoding and decoding may be performed using a decoding function to decode the encoded instance, whereby obtaining a decoded instance represented back in the feature space. In some exemplary embodiments, the encoding and decoding functions may be determined using an autoencoder, as is illustrated in FIG. 4.

FIG. 4 exemplifies that an Input Vector 410, representing an instance, is encoded-decoded using Encoding-Decoding Function 420 to obtain an Output Vector 430, representing the decoded instance. Encoding-Decoding Function 420 comprises Encoding Function 422 encoding Input Vector 410 to an Encoded Vector 425, and applying Decoding Function 428 on Encoded Vector 425 to obtain Output Vector 430.

In some exemplary embodiments, Encoding Function 422 may be an ANN. Additionally or alternatively, Decoding Function 428 may be an ANN. In some exemplary embodiments, the ANNs may be trained so as to provide a minimization of a distance between Input Vector 410 and Output Vector 430. After the training is performed, Encoded Vector 425 may be considered as providing an encoding of the features of the instance, using a reduced number of instances, but while retaining an embodiment of the important qualities thereof. In some exemplary embodiments, Encoding-Decoding Function 420 may be configured to filter non-important data and retain important data, using the features of Encoded Vector 425.

On Step 320, a first measurement may be computed. The first measurement may be computed based on the seen instances and the decoded seen instances. In some s exemplary embodiments, a difference between a seen instance and its corresponding decoded seen instance may be measured, such as using the delta function (Δ). A statistical metric may measure the statistical distribution of the random variable representing the values of the delta function, such as a mean value, a variance of the values of the delta function, a standard deviation of the values of the delta function, or the like.

On Step 340, similarly to Step 320, unseen instances may be encoded and decoded to obtain decoded unseen instances.

On Step 350, similarly to Step 320, a second measurement may be computed. The second measurement may be based on the same statistical metric of Step 320, measuring a statistical difference between unseen instances and their corresponding unseen decoded instances.

In some exemplary embodiments, using the statistical metric that is based on the delta function, a data drift may be identified (160) in situations where the original encoding, utilized by the encoding-decoding function (e.g., Encoded Vector 425 of FIG. 4), no longer provides an adequate encoding of the information in the instances. This may be identified implicitly using the values of the delta function. In some exemplary embodiments, due to a change in the distribution of the instances, as observed in the unseen dataset, the delta function may yield a significantly different random variable than that was exhibited based on the seen dataset.

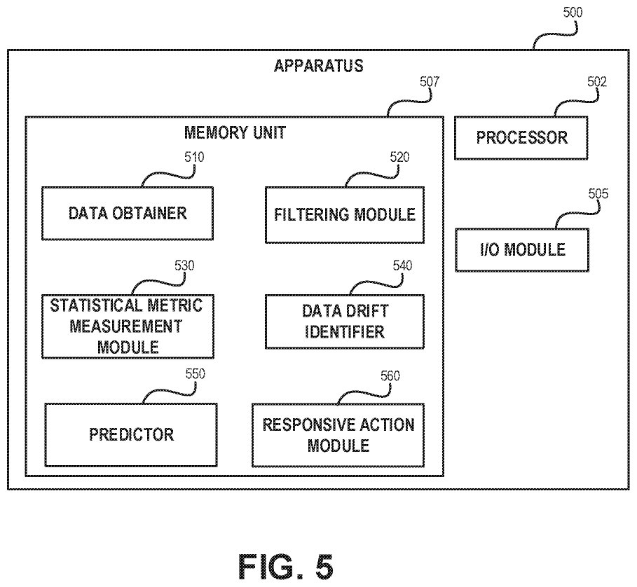

Referring now to FIG. 5, showing an apparatus, in accordance with some exemplary embodiments of the disclosed subject matter.

In some exemplary embodiments, Apparatus 500 may comprise one or more Processor(s) 502. Processor 502 may be a Central Processing Unit (CPU), a microprocessor, an electronic circuit, an Integrated Circuit (IC) or the like. Processor 502 may be utilized to perform computations required by Apparatus 500 or any of it subcomponents.

In some exemplary embodiments of the disclosed subject matter, Apparatus 500 may comprise an Input/Output (I/O) Module 505. I/O Module 505 may be utilized by Responsive Action Module 560 to provide an output to a user, such as, for example, in the case that a data drift was identified. Additionally or alternatively, I/O Module 505 may be utilized by Data Obtainer 510 in order to receive input. Additionally or alternatively, I/O Module 505 may be utilized to instruct an automated process to perform a responsive action in response to an identification of a data drift, such as to replace a hardware component associated with obtaining the instances.

In some exemplary embodiments, Apparatus 500 may comprise Memory Unit 507. Memory Unit 507 may be a hard disk drive, a Flash disk, a Random Access Memory (RAM), a memory chip, or the like. In some exemplary embodiments, Memory Unit 507 may retain program code operative to cause Processor 502 to perform acts associated with any of the subcomponents of Apparatus 500. In some exemplary embodiments, Memory Unit 507 may be configured to retain a list of principal components determined using PCA, a trained ANN, such as trained using an autoencoder, computed measurements of statistical metrics, or the like.

Memory Unit 507 may comprise one or more components as detailed below, implemented as executables, libraries, static libraries, functions, or any other executable components.

In some exemplary embodiments, a Data Obtainer 510 may be configured to obtain seen datasets, unseen datasets, or the like. The datasets may be obtained from a repository such as an archive, a server, or the like. Additionally or alternatively, the datasets may be obtained using sensors such as cameras, microphones, X-RAY scanners, or the like. The data comprising the datasets may be unclassified, classified, or the like. In some exemplary embodiments, Data Obtainer 510 may obtain labeled data, such as to be used for training and testing Predictor 550, unlabeled data, such as on which Predictor 550 is used in production, or the like. In some exemplary embodiments, Predictor 550 may implement unsupervised learning and may utilize unlabeled data for training.

In some exemplary embodiments, Filtering Module 520 may be configured to filter the important qualities of the data. Filtering Module 520 may utilize algorithms such autoencoder, PCA, ANN, projection functions, or the like. Additionally or alternatively, Filtering Module 520 may be configured to project instances in the feature space to a second feature space that is smaller than the feature space, such as having a reduced number of dimensions. Additionally or alternatively, Filtering Module 520 may be configured to utilize an encoder-decoder function such as autoencoder, or the like. The Filtering Module 520 may yield, for an instance, a decoded instance.

In some exemplary embodiments, Statistical Metric Measurement Module 530 may be configured to determine a statistical metric of instances. In some exemplary embodiments, Statistical Metric Measurement Module 530 may be configured to compute a statistical measurement measuring a distribution of instances. Additionally or alternatively, the statistical measurement may be computed using a second feature space, and based on values thereof, such as obtained based on a projection of the instances. In some exemplary embodiments, Statistical Metric Measurement Module 530 may be configured to compute a relation between two features in the second feature space. Additionally or alternatively, the relation may be a relation between a set of features and an additional feature of the second feature space. In some exemplary embodiments, Statistical Metric Measurement Module 530 may be configured to compute measurements of a random variable, such as the random variable of the values of a delta function. Additionally or alternatively, Statistical Metric Measurement Module 530 may be configured to determine a distribution of the differences between instances and their corresponding decoded instances.

In some exemplary embodiments, Data Drift Identifier 540 may be configured to identify a data drift. In some exemplary embodiments, Data Drift Identifier 540 may identify a data drift based on the difference between the first measurement and the second measurement, such as measured by Statistical Metric Measurement Module 530. As an example, consider a predictor that is used in order to predict if an image shows a child or an adult. The seen data may comprise children in the ages 3-5 years and adults in ages above 50. An image may have 1024×1024 pixels, each of which may be considered as a feature. So, each instance may be represented by 1,048,576 features. Projecting the images to a smaller second feature space may reduce the number of features. For example, the second feature space may be represented using a reduced number of features by an order of magnitude, such as 100 features, 200 features, or the like. Statistical Metric Measurement Module 530 may yield that the covariance of the instances comprising the seen second features is 0.5 and that the covariance of the instances comprising the unseen second feature space is 0.8. In some exemplary embodiments, Data Drift Identifier 540 may be configured to identify a data drift if the relative difference between the first measurement (0.5) and the second measurement (0.8) is more than 50% ((0.8−0.5)/0.5)>0.5).

Referring again to the above image example, projecting 1024×1024 to a 100 features space may yield an improvement in performances. The seen dataset and the unseen data set may comprise millions of instances. By using the disclosed subject matter, finding statistical differences between the seen and the unseen is feasible compared to finding statistical differences between instances that may be comprised by 1024×1024 features.

In some exemplary embodiments, Predictor 550 may be configured to estimate a label for an instance. Predictor 550 may be trained using a portion of the seen data and tested using another portion of the seen data. In some exemplary embodiments, Predictor 550 may comprise a predictive model that is trained using a seen dataset of instances. Additionally or alternatively, in case of a supervised learning, the training may be based on the seen dataset and labels thereof. In some exemplary embodiments, Predictor 550 may implement a supervised learning technique, such as but not limited to Support Vector Machines, linear regression, logistic regression, naive Bayes, linear discriminant analysis, decision trees, k-nearest neighbor algorithm, Neural Networks, Similarity learning, or the like. Additionally or alternatively, Predictor 550 may be implemented using unsupervised learning, such as using CNN, RNN, clusters, or the like.

In some exemplary embodiments, Predictor 550 may be external to Apparatus 500. Predictor 550 may be a part of an application, a software, a library, or the like. Predictor 550 may be configured to estimate a label to an unseen data instance. As an example, Predictor 550 may be distributing in order to estimate if a person has cancer based on X-RAY scans.

In some exemplary embodiments, Responsive Action Module 560 may be configured to perform a responsive action in response to an identification of a data drift by Data Drift Identifier 540. In some exemplary embodiments, Responsive Action Module 560 may be configured to send notification regarding data drifted that may have been identified. The notifications may be an email, a push notification, or the like. In some exemplary embodiments, the notifications may comprise additional data regarding s the data drift such as which unseen data caused the data drift. Additionally or alternatively, the notifications may comprised a recommendation for a mitigation action such as replacing hardware, what hardware to replace, a recommendation regarding retraining the predictor, or the like. In some exemplary embodiments, Responsive Action Module 560 may be configured to perform the responsive action automatically, such as to instruct a replacement of a hardware component, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a seen dataset, wherein the seen dataset comprises seen instances, each of which comprising feature values in a feature space;
determining a first measurement of a statistical metric of the seen dataset;
obtaining an unseen dataset, wherein the unseen dataset comprises unseen instances, each of which comprising features values in the feature space;
determining a second measurement of the statistical metric of the unseen dataset;
identifying a data drift in the unseen dataset with respect to the seen dataset based on the first and second measurements of the statistical metric; and
performing a responsive action based on the identification of the data drift.

2. The method of claim 1, further comprises:
wherein said determining the first measurement comprises:
projecting the instances of the seen dataset to a second feature space, wherein the second feature space is smaller than the feature space; and
computing the first measurement based on a relation between at least two features in the second feature space, wherein the first measurement is computed based on the projected instances of the seen dataset; and
wherein said determining the second measurement comprises:
projecting the instances of the unseen dataset to the second feature space; and
computing the second measurement based on the relation between the at least two features in the second feature space, wherein the second measurement is computed based on the projected instances of the unseen dataset.

3. The method of claim 2, wherein said projecting the instances of the seen dataset and the instances of the unseen dataset is performed by applying a trained Artificial Neural Network (ANN).

4. The method of claim 3 further comprises: utilizing a predictor to predict a label for the unseen instances of the unseen dataset, wherein the predictor implements a predictive model that does not utilize the trained ANN.

5. The method of claim 3, wherein the predictor is implemented using a machine learning technique that is based on an Artificial Neural Network (ANN).

6. The method of claim 2, wherein the relation between the at least two features in the second feature space is a correlation measurement of the at least two features.

7. The method of claim 2, wherein the statistical metric comprises a distribution of values of a first feature in the second feature space and a distribution of values of a second feature in the feature space.

8. The method of claim 2, wherein the statistical metric is based on a regression modeling a feature of the second feature space, wherein the regression is computed based on a subset of features of the second feature space, wherein the subset excludes the feature of the second feature space.

9. The method of claim 1, further comprises:
wherein said determining the first measurement of the statistical metric of the seen dataset comprises: performing Principal Component Analysis (PCA) on the seen dataset, whereby obtaining a first PCA variance;
wherein said determining the second measurement of the statistical metric of the unseen dataset comprises: performing PCA on the unseen dataset, whereby obtaining a second PCA variance; and
wherein said identifying the data drift is performed based on the first PCA variance and the second PCA variance.

10. The method of claim 1, wherein said obtaining the unseen dataset is performed using a hardware component; wherein said performing the responsive action comprises replacing the hardware component.

11. The method of claim 1, further comprises:
determining an encoding-decoding function, wherein the encoding-decoding function is configured to transform an instance given in the feature space to a decoded instance in the feature space, wherein the transformation of the instance is performed through an encoded feature space, and decoding therefrom back to the feature space;
wherein said determining the first measurement comprises:
applying the encoding-decoding function on the seen dataset to provide a decoded seen dataset; and
computing the first measurement using a statistical difference metric based on the seen dataset and the decoded seen dataset;
wherein said determining the second measurement comprises:
applying the encoding-decoding function on the unseen dataset to provide a decoded unseen dataset; and
computing the second measurement using the statistical difference metric based on the unseen dataset and the decoded unseen dataset.

12. The method of claim 11, wherein said determining the encoding-decoding function comprises utilizing an autoencoder.

13. The method of claim 11,
wherein said computing the first measurement comprises:
computing, for each instance in the seen dataset, a value of a delta function (Δ), wherein the delta function is defined Δ(i)=i−dec(enc(i)), wherein i is the each instance, wherein enc(i) is an encoding function from the feature space to the encoded feature space, wherein dec(x) is a decoding function from the encoded feature space to the feature space, wherein dec(enc(i)) is the encoding-decoding function; and
computing the statistical difference metric by computing a measurement of a random variable of values of the delta function in the seen dataset; and
wherein said determining the second measurement comprises:
computing, for each instance in the unseen dataset, a value of the delta function (Δ); and
computing the statistical difference metric by computing a measurement of the random variable of values of the delta function in the unseen dataset.

14. A non-transitory computer readable medium retaining program instructions, which program instructions when read by a processor, cause the processor to perform:
obtaining a seen dataset, wherein the seen dataset comprises seen instances, each of which comprising feature values in a feature space;
determining a first measurement of a statistical metric of the seen dataset;
obtaining an unseen dataset, wherein the unseen dataset comprises unseen instances, each of which comprising features values in the feature space;
determining a second measurement of the statistical metric of the unseen dataset;
identifying a data drift in the unseen dataset with respect to the seen dataset based on the first and second measurements of the statistical metric; and
performing a responsive action based on the identification of the data drift.

15. The non-transitory computer readable medium of claim 14,
wherein said determining the first measurement comprises:
projecting the instances of the seen dataset to a second feature space, wherein the second feature space is smaller than the feature space; and
computing the first measurement based on a relation between at least two features in the second feature space, wherein the first measurement is computed based on the projected instances of the seen dataset; and
wherein said determining the second measurement comprises:
projecting the instances of the unseen dataset to the second feature space; and
computing the second measurement based on the relation between the at least two features in the second feature space, wherein the second measurement is computed based on the projected instances of the unseen dataset.

16. The non-transitory computer readable medium of claim 14,
wherein said determining the first measurement of the statistical metric of the seen dataset comprises: performing Principal Component Analysis (PCA) on the seen dataset, whereby obtaining a first PCA variance;
wherein said determining the second measurement of the statistical metric of the unseen dataset comprises: performing PCA on the unseen dataset, whereby obtaining a second PCA variance; and
wherein said identifying the data drift is performed based on the first PCA variance and the second PCA variance.

17. The non-transitory computer readable medium of claim 14, wherein said obtaining the unseen dataset is performed using a hardware component; wherein said performing the responsive action comprises replacing the hardware component.

18. The non-transitory computer readable medium of claim 14, wherein said program instructions when read by the processor, further cause the processor to perform:
determining an encoding-decoding function, wherein the encoding-decoding function is configured to transform an instance given in the feature space to a decoded instance in the feature space, wherein the transformation of the instance is performed through an encoded feature space, and decoding therefrom back to the feature space;
wherein said determining the first measurement comprises:
applying the encoding-decoding function on the seen dataset to provide a decoded seen dataset; and
computing the first measurement using a statistical difference metric based on the seen dataset and the decoded seen dataset;
wherein said determining the second measurement comprises:
applying the encoding-decoding function on the unseen dataset to provide a decoded unseen dataset; and
computing the second measurement using the statistical difference metric based on the unseen dataset and the decoded unseen dataset.

19. The non-transitory computer readable medium of claim 18,
wherein said computing the first measurement comprises:
computing, for each instance in the seen dataset, a value of a delta function (Δ), wherein the delta function is defined Δ(i)=i−dec(enc(i)), wherein i is the each instance, wherein enc(i) is an encoding function from the feature space to the encoded feature space, wherein dec(x) is a decoding function from the encoded feature space to the feature space, wherein dec(enc(i)) is the encoding-decoding function; and
computing the statistical difference metric by computing a measurement of a random variable of values of the delta function in the seen dataset; and
wherein said determining the second measurement comprises:
computing, for each instance in the unseen dataset, a value of the delta function (Δ); and
computing the statistical difference metric by computing a measurement of the random variable of values of the delta function in the unseen dataset.

20. A computerized apparatus having a processor and coupled memory, the processor being adapted to perform:
obtaining a seen dataset, wherein the seen dataset comprises seen instances, each of which comprising feature values in a feature space;
determining a first measurement of a statistical metric of the seen dataset;
obtaining an unseen dataset, wherein the unseen dataset comprises unseen instances, each of which comprising features values in the feature space;
determining a second measurement of the statistical metric of the unseen dataset;
identifying a data drift in the unseen dataset with respect to the seen dataset based on the first and second measurements of the statistical metric; and
performing a responsive action based on the identification of the data drift.
